(19) United States
(12) Patent Application Publication
(10) Pub. No.: US 2004/0056550 A1
(43) Pub. Date: Mar. 25, 2004

(54) Stator for an electric machine and method for producing the same

(76) Inventors: Andreas Grundl, Munchen (DE); Bernhard Hoffmann, Starnberg (DE)

Correspondence Address: WOOD, HERRON & EVANS, LLP, 2700 CAREW TOWER, 441 VINE STREET, CINCINNATI, OH, 45202, US

(21) Appl. No.: 10/433,194

(22) PCT Filed: Nov. 30, 2001
(86) PCT No.: PCT/EP01/14011

(30) Foreign Application Priority Data
Nov. 30, 2000 (DE) 100 59 575.8

(51) Int. Cl. H02K 1/00; H02K 23/42; H02K 15/14

(52) U.S. Cl. 310/187; 29/596; 29/831; 310/179

(57) ABSTRACT

An electric machine with a stator which comprises several grooves arranged adjacent to one another and forming winding chambers for accommodating at least one stator winding. Each stator winding is constructed of conductor bars with an essentially rectangular cross-section in the winding chambers and conductor portions forming winding overhangs. The conductor bars are electrically connected in an integral manner at their ends with the conductor portions in that each of the conductor portion comprises an essentially U-shaped end section with two opposite legs whose inner sides facing towards each other are joined with corresponding side faces of a end section of one of the conductor bars.

### BACKGROUND OF THE INVENTION

The invention relates to an electric machine and a stator for an electric machine and a method for manufacturing same.

### BACKGROUND OF THE INVENTION

Such electric machines and stators for them are known in the state of the art in the most different configurations.

From EP 1 039 616 A2 an electric machine with an internal rotor and a stator is known which comprises several grooves arranged adjacent to one another. Stator windings are built from conductor bars arranged in the grooves as well as from conductor portions forming winding overhangs, with the conductor bars being riveted at their ends to the conductor portions.

From DE 43 21 236 C1 a multi-phase electric machine is known with a winding from flat conductor formed parts which are inserted in grooves. At the transition from a groove formed in the stator into a winding overhang, an increase in the conductor cross-section towards the groove width takes place. Joints all of which are located at the winding overhang end faces are formed by welding or brazing.

The term “electric machine” as used herein is to be understood as covering both an electric motor and an electric generator, regardless of whether the electric machine is designed as a rotary machine or, for example, as a linear motor.

An essential factor which contributes significantly to the efficiency of an electric machine is the space factor of the (stator) winding (i.e. the ratio of the winding wire volume to the total volume of the winding chamber). Another factor which contributes considerably to the efficiency is the design of the winding overhangs (axially protruding beyond the stator body) of the stator winding. Due to the fact that, in particular, the winding portion axially protruding beyond the stator body is electromagnetically not effective, it has been endeavoured to design this portion of the windings as space-saving as possible. This is of particular importance with multi-phase machines, because in this case the spatial design of the winding overhangs is particularly expensive.

In order to increase the space factor of the (stator) winding it is known to install conductor bars with a rectangular cross-section into the winding chambers, which are connected via corresponding conductor portions in the coil ends with the respective windings.

Problem on Which the Invention is Based

The joints of the conductor bars in the winding chambers with the conductor portions in the coil ends are an essential factor for the reliability of the respective machine. This holds true all the more as the spatially very limited conditions in the area of the winding overhangs exclude a number of known joining techniques.

All known concepts have in common that with a sufficiently compact construction, the reliability is no longer achieved in large-scale production applications. Moreover, known manufacturing approaches are very expensive.

Spot welding, for example, is also to be excluded, at least with machines in the power range below one megawatt, because the risk of the welding electrodes adhering to the parts to be welded is very high.

### OBJECT OF THE INVENTION

It is the object of the resent invention to provide a compact electric machine which can economically be manufactured in large-scale production as well as a method for manufacturing same.

Inventive Solution

In order to eliminate the drawbacks of the state of the art, the invention teaches an electric machine which is defined by the characteristics of claim 1, as well as a method for manufacturing such an electric machine.

Construction and Developments of the Inventive Solution

According to the invention, the object is solved by an electric machine with a stator which comprises several grooves arranged distributed about its circumference and forming winding chambers for accommodating at least one stator winding, with each stator winding being constructed of conductor bars of an essentially rectangular cross-section in the winding chambers and conductor portions forming winding overhangs, with the conductor bars being connected at their ends with the conductor portions in such a manner that each of the conductor portions comprises an essentially U-shaped end section with two opposite legs whose inner sides facing each other are joined with corresponding side faces of an end section of one of the conductor bars.

This solution enables a particularly reliable and economic manufacture of the stator windings with excellent electric and mechanic properties, even under large-scale production conditions.

In a first preferred embodiment, the joint between the end section of the conductor bar and the end section of the conductor portion comprises a layer of brazing solder, preferably silver brazing solder, tin brazing solder, or the like. Alternatively, the joint between the end section of the conductor bar and the end section of the conductor portion may comprise a layer of high-temperature soft solder, preferably with a melting point of at least 380° C.

In order to prevent the occurrence of a thickening (with the associated space problem) in the area of the winding overhangs, preferably the end section of the conductor bar is tapered by at least approx. the wall thickness of the essentially U-shaped end section of the conductor portion. This is provided for all side faces at which the end section of the conductor portion is in contact with the end section of the conductor bar.

If the end section of the conductor portion is in contact and in (an integral) connection with only two (e.g. opposite) side faces of the end section of the conductor bar, the packing density of the winding layers in the winding overhang can be maintained equal to that on the winding groove.

Preferably each of the opposite legs comprises a projection on its inner face facing the end section of the conductor bar, which makes contact with the corresponding side faces of the end section of the conductor bar. This facilitates a defined sequence of the integral joining process.

The integral joint can be effected in a particularly simple manner by means of electric impulse welding.

Especially with multi-phase electric machines, it is necessary that the winding overhangs are laterally offset relative to one another. This can be achieved most easily in that the conductor portion protrudes beyond the end section of the conductor bar and is cranked.

The invention also relates to a method for manufacturing an electric machine with a stator which comprises several grooves arranged distributed about its circumference and forming winding chambers for accommodating at least one stator winding, as defined above, with the steps: inserting an essentially rectangular conductor bar into a winding chamber so that an end section of the conductor bar protrudes beyond at least one end face of the stator, integrally joining of a conductor portion with the protruding end section of the conductor bar, with the conductor portion comprising an essentially U-shaped end section with two opposite legs whose inner sides facing each other are joined with corresponding side faces of an end section of one of the conductor bars.

The two opposite legs thereby encompass the respective side faces of the end section of the conductor bar and are pressed against these.

Simultaneously with this pressing operation or at a later time, electric contact electrodes are applied to the conductor bar and the conductor portion, through which a predefined electric power impulse is then sent which is sufficient to melt the material at the joint(s).

An essential aspect is that the places where the electric contact electrodes are applied to the conductor bar and the conductor portion are different from the pressure-subjected places. This avoids bonding or melting of the contact electrodes with the parts to be joined.

According to the invention the power of the impulse is determined to be such that in the joint area essentially no heat dissipates to the environment. This is achieved primarily by introducing the power into the parts to be joined during a time interval as short as possible. This causes the melting process to take place so rapidly that hardly any energy is dissipated to the environment prior to the completion of the joining process.

Further characteristics, properties, advantages, and possible modifications will become obvious for those with skill in the art from the following description in which reference is made to the accompanying drawings.

FIG. 1 schematically illustrates the plan view of a development of a stator for an electric motor according to the invention with sectioned stator windings.

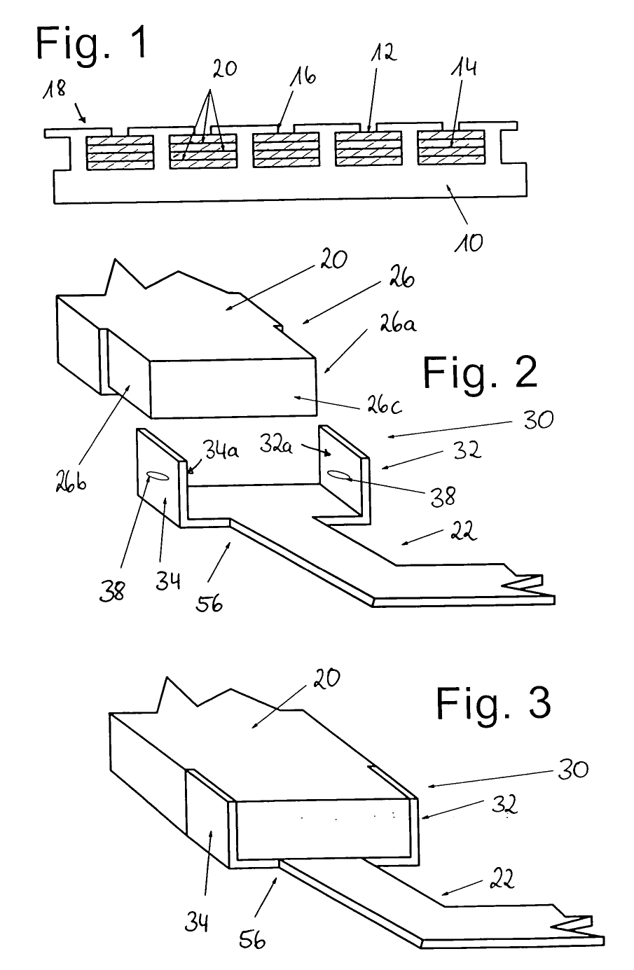

FIGS. 2 and 3 schematically illustrate in a perspective view how the conductor bar of a winding according to FIG. 1 is to be joined with a conductor portion forming the winding overhang.

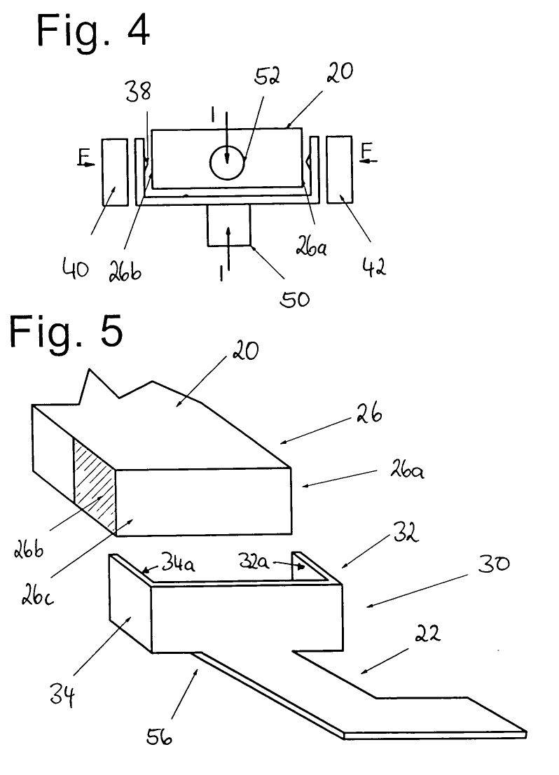

FIG. 4 illustrates in a schematic plan view how the conductor bar and the conductor portion from FIGS. 2, 3 are pressed together and supplied with an electric power impulse.

FIG. 5 shows an alternative embodiment of a conductor portion in a schematic perspective view.

### DETAILED DESCRIPTION OF THE PREFERRED EMBODIMENTS

FIG. 1 shows a plan view of a portion of a development of a stator 10 of an internal rotor motor machine (not shown in detail), with the invention being also applicable to an external rotor machine. In the present embodiment the stator 10 is built from stacked laminations, but could also consist of iron particles pressed to the respective shape.

The stator 10 has grooves 12 arranged adjacent to each other, which form the winding chambers for the respective stator coil windings 14. In the illustrated embodiment the winding chambers have an essentially rectangular cross-section, with slots 16 being provided in the side facing towards the rotor (not shown). Thus, teeth 18 are formed between two each slots 16.

Each stator winding 14 is formed from conductor bars 20 with an essentially rectangular cross-section, which have been inserted into the winding chambers and joined with conductor portions 22 which form winding overhangs (see FIG. 2). The conductor bars 20 are integrally and electrically connected at their end sections 26 with the conductor portions 22. This is realised in that each of the conductor portions 22 comprises an essentially U-shaped end section 30 with two opposite legs 32, 34 whose inner sides 32a, 34a facing each other are joined with corresponding side faces 26a, 26b of the end section 26 of one of the conductor bars 20. FIGS. 2 and 3 only show the joint between one end of a conductor bar 20 and one half of a (otherwise mirror image) conductor portion 22.

In order to produce this joint, a layer of (silver) brazing solder is applied to the side faces 26a, 26b of the end section 26 of the conductor bar 20.

As shown in the embodiment of FIG. 3, the end section 26 of the conductor bar 20 is tapered by approx. the wall thickness of the essentially U-shaped end section 30 of the conductor portion 22. It is thereby achieved that the space conditions in the area of the winding overhangs are not too restricted or that the winding overhangs can be arranged very compact so that the electromagnetically not effective part of the stator coil winding is relatively small. Due to the fact that the conductor bars 20 and the conductor portions 22 are joined with each other via the two side faces 26a, 26b or via the inner faces 32a, 34a, respectively, a very large interface and thus a mechanically and electrically very reliable connection is achieved.

At the inner faces 32a, 34a facing each other, of the opposite legs 32, 34, a projection 38 in the form of a cone is provided with is embossed from the outside. Due to the fact that the joint between the conductor bar 20 and the conductor portion 22 is made be electric impulse welding as will be explained in more detail below, this projection 38 achieves a reproducible electric contact making in the welding process and thus a defined melting process of the material to be joined.

In the manufacture of an electric machine with the above described stator 10, it is to be proceeded as follows: First, a stator 10 (see FIG. 1) is provided which has the appropriate grooves 12. Into these grooves 12 the rectangular conductor bars 20 are inserted which are dimensioned in such a manner that at both end faces of the stator 10 one each end section 26 of the conductor bar 20 is protruding. By using conductor bars 20 whose shape is matched to the shape of the grooves 12, the packing density (i.e. the space factor) can be considerably increased compared to the standard coil windings from wire rod.

Subsequently, a conductor portion 22 is joined with the protruding end section 26 of the conductor bar 20. For this purpose, the two opposite legs 32, 34 of the end section 30 of the conductor portion 22 are pressed against the respective side faces 26a, 26b of the end section 26 of the conductor bar 20 by means of two press jaws 40, 42 (see FIG. 4). Contrary to conventional tools for electric impulse welding, no current flows through this press jaws 40, 42. Rather, these are merely moved towards each other by the forces F, so that the two opposite legs 32, 34 of the end section 30 of the conductor portion 22 are pressed against the respective side faces 26a, 26b of the end section 26 of the conductor bar 20. The tips of the projections 38 thereby come into contact with the side faces 26a, 26b of the end section 26. Simultaneously with the pressing together and the associated contact between the projections 38 and the side faces 26a, 26b, electric contacts are applied at each of the conductor bar 20 and the conductor portion 22, through which a predefined electric power impulse flows which is sufficient to melt the material at the joint(s).

As is illustrated in FIG. 4, the places where the electric contacts are applied to the conductor bar 20 and the conductor portion 22 are different from places where the press jaws 40, 42 press the two opposite legs 32, 34 of the end section 30 of the conductor portion 22 against the respective side faces 26a, 26b of the end section 26 of the conductor bar 20. In the illustrated embodiment the electric power impulse is introduced through two contact pads 50, 52 which, on the one hand, are applied to a middle web 56 (see FIGS. 2, 4) of the conductor portion 22 and, on the other hand, to an end face 26c of the conductor bar 20. It goes without saying that—dependent on the spatial conditions—other places for the introduction of the electric power impulse can be used at the conductor portion 22 or the conductor bar 20, respectively. That which is decisive is that the contact points for the electric power impulse are different from the places where the conductor portion 22 is joined (welded) to the conductor bar 20. Due to the fact that no electric current flows through the places of the introduction of force, bonding of the press jaws 40, 42 to one of the parts to be joined is avoided.

In order to carry out the joining process as efficiently as possible, in an embodiment (not shown in detail) of the two contact pads 50, 52 a soft solder (e.g. in the form of a soft solder wire through a duct) is fed to their interface with the respective part (conductor portion 22 or conductor bar 20). Upon the introduction of the electric power impulse, the soft solder will also melt. While the press jaws 40, 42 are still urging the two legs 32, 34 of the conductor portion 22 against the end section 26 of the conductor bar 20, the contact pads 50, 52—as long as the soft solder is still liquid—are lifted off the conductor portion 22 or the conductor bar 20, respectively. Only afterwards, the two press jaws 40, 42 are withdrawn. This ensures that none of the contact pads 50, 52 adheres to the conductor portion 22 or the conductor bar 20.

FIG. 5 shows a further embodiment of the conductor portion 22 or of the conductor bar 20, respectively, where the conductor portion 22 contacts the side faces 26a, 26b of the end section 26 of the conductor bar 20 only with the two opposite legs 32, 34 of its end section 30. This embodiment is advantageous in that the distance to the neighbouring conductor bar 20 in the same winding chamber is not affected by the joint of the conductor bar 20 with its respective conductor portion 22. Here, the contact pad 50 to be applied to the conductor portion 22 can be applied to the middle piece 56 overlapping the end face 26c of the conductor bar 20, and the contact pad 52 to be applied to the conductor bar 20 can be applied to the opposite end of the conductor bar 20.

An essential advantage of this embodiment is that the end section 26 need not comprise any tapering in order to realise a space-saving joint between the conductor bars 20 and the conductor portion 22 in the critical orientations (in particular relative to the neighbouring conductor bars).

The ratios of the individual parts and sections therefrom and their material thicknesses shown in the figures are not to be understood as being limiting. Rather, individual dimensions can differ from those shown.

1. An electric machine with a stator (10) which comprises several grooves (12) arranged adjacent to one another and forming winding chambers for accommodating at least one stator winding (14), with each stator winding (14) being constructed of conductor bars (20) of an essentially rectangular cross-section in the grooves (12) and conductor portions (22) forming winding overhangs, with the conductor bars (20) being electrically connected at their ends with the conductor portions (22) in such a manner that each of the conductor portions (22) comprises an essentially U-shaped end section (30) with two opposite legs (32, 34) whose inner sides (32a, 34a) facing each other are joined with corresponding side faces (26a, 26b) of an end section (26) of one of the conductor bars (20).

2. The electric machine with a stator according to claim 1, with the joint between the end section (26) of the conductor bar (20) and the end section (30) of the conductor portion (22) comprising a layer of brazing solder, preferably silver brazing solder, tin brazing solder, or the like.

3. The electric machine with a stator according to claim 1, with the joint between the end section (26) of the conductor bar (20) and the end section (30) of the conductor portion (22) comprising a layer of high-temperature soft solder, preferably with a melting point of at least approx. 380° C.

4. The electric machine with a stator according to claim 1, with the end section (26) of the conductor bar (20) being tapered by at least approx. the wall thickness of the essentially U-shaped end section (30) of the conductor portion (22).

5. The electric machine with a stator according to claim 1, with each of the opposite legs (32, 34) comprising a projection (38) at its inner face (32a, 34a) facing towards the end section (26) of the conductor bar (20), which makes contact with the corresponding side faces (26a, 26b) of the end section (26) of the conductor bar (20).

6. The electric machine with a stator according to claim 2 or 3, with the integral joint being made by electric impulse welding.

7. The electric machine with a stator according to claim 1, with the conductor portion (22) protruding beyond the end section (26) of the conductor bar (20) and being cranked.

8. A method for manufacturing an electric machine with a stator (10) which comprises several grooves (12) arranged distributed about its circumference and forming winding chambers for accommodating at least one stator winding (14) according to one of the previous claims, with the steps:
inserting an essentially rectangular conductor bar (20) into a groove (12) so that an end section (26) of the conductor bar (20) protrudes beyond at least one end face of the stator (10),
integral joining of a conductor portion (22) with the protruding end section (26) of the conductor bar (20), with the conductor portion (22) comprising an essentially U-shaped end section (30) with two opposite legs (32, 34) whose inner sides (32a, 34a) facing each other are joined with corresponding side faces (26a, 26b) of an end section (26) of one of the conductor bars (20).

9. The method according to claim 8, with the step of the integral joining comprising a pressing operation of the two opposite legs (32, 34) against the respective side faces (26a, 26b) of the end section (26) of the conductor bar (20).

10. The method according to claim 8, wherein simultaneously with the pressing operation or at a later time electric contacts (50, 52) are applied to each of the conductor bar (20) and the conductor portion (22), through which a predefined electric power impulse flows which is sufficient to melt the material at the joint(s).

11. The method according to claims 9 and 10, wherein the places at which the electric contacts (50, 52) are applied to the conductor bar (20) and to the conductor portion (22) are different from the pressure-subjected places.

12. The method according to claim 10, wherein the power of the impulse is determined in such a manner that in the area of the joint essentially no heat is dissipated to the environment.
